(19) United States
(12) Patent Application Publication
(10) Pub. No.: US 2011/0239753 A1
(43) Pub. Date: Oct. 6, 2011

(54) SAFE TIRE

(76) Inventor: Kiana Shannon, Milwaukee, WI (US)

(21) Appl. No.: 13/076,206

(22) Filed: Mar. 30, 2011

Related U.S. Application Data
(60) Provisional application No. 61/319,710, filed on Mar. 31, 2010.

(51) Int. Cl. B60C 23/04

(52) U.S. Cl. 73/146.8

(57) ABSTRACT

A pneumatic tire pressure indication system comprising a pneumatic pressure indicator strip containing a predetermined quantity of alcohol or glycol based low viscosity fluid that can be produced in a number of different colors. When tire pressure is at a predetermined amount (below manufacturer's specifications), the tire pressure indicator strip has a circular cross-section. At proper pressure, the strip becomes elliptical and the colored fluid is seen through the transparent side-wall of the pressure indicating strip touching the tire pressure indicator strip. Thus, relative tire pressures can be observed at a glance

### CROSS-REFERENCE TO RELATED APPLICATION

The present application is related to and claims priority from prior provisional application Ser. No. 61/319,710, filed Mar. 31, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of tires and more specifically relates to smart tires providing indication means such that a driver is able to visually determine a safe air pressure is present in tires.

2. Description of the Related Art

In modern society, automobiles are an essential transportation means as they may be used to efficiently transport people and goods between various locations. Modern vehicles used on streets and highways typically use rubber tires as the means to make contact between the moving vehicle and the non-moving road surface to provide shock absorption and facilitate vehicle handling/maneuvering. Inflatable or pneumatic tires have particular maintenance requirements that should be followed in order to realize the greatest possible life of the tires and to meet safety requirements.

Tire inflation pressures are normally specified by vehicle manufacturers, which permit safe operation within the specified load rating and vehicle loading. Most tires are stamped with a maximum pressure rating. For passenger vehicles and light trucks, the tires should be inflated to what the vehicle manufacturer recommends, which is usually located on a decal just inside the driver's door or in the vehicle owners handbook. Tires should not generally be inflated to the pressure on the sidewall; this is the maximum pressure, rather than the recommended pressure. It may be very dangerous to allow tire pressure to drop below the recommended placard vehicle pressure, although this commonly occurs because of non-descript leakage. The reason that this is a dangerous condition is that it increases the amount of tire wall movement creating heat and uneven tire contact with the road surface. Should a low pressure tire be forced to perform an evasive maneuver, the tire wall will be more pliable than had it been at a higher pressure, thus causing it to “roll” under the wheel. This increases the entire roll movement of the car, potentially causing a vehicle to lose control.

Further, with low tire pressure—due to the side wall being more pliable—the tire will absorb more of the irregular forces from normal driving, and with this constant bending of the side wall as it absorbs the contours of the road, it heats up the tire wall to possibly dangerous temperatures, as well as degrades the steel wire reinforcement; this often leads to side wall blow-outs. Due to the low tire pressure, the side wall at the contact area may also temporarily collapse when contacting a pot-hole, thereby wedging the tire between the wheel and road, resulting in a tire laceration and blow-out, as well as a damaged wheel. Feathering occurs on the junction between the tire tread and side wall, as a result of too low tire pressures. This is as a result of the inability of the tire to perform appropriately during cornering forces, leading to aberrant and shearing forces on the feathering area. This is due to the tire moving sideways underneath the wheel as the tire pressures are insufficient to transmit the forces to the wheel and suspension. The inconvenience and time required for checking tire pressure is the single largest factor in under-inflated tires on the nation's highways, an easier method and means is needed. Likewise, over-inflation of tires is a safety hazard. Proper tire pressures maximize the life of the tire, save fuel consumption, greatly reduce tire sidewall failure, and maximize tread life.

Various attempts have been made to solve the above-mentioned problems such as those found in U.S. Pat. Nos. 4,851,809; 6,055,925; 4,723,445; 6,832,573, 2,800,795; and 5,377,539. This prior art is representative of tires with pressure indicators. None of the above inventions and patents, taken either singly or in combination, is seen to describe the invention as claimed.

Ideally, a tire pressure indicator should be quick, convenient and accurate, yet, would operate reliably and be manufactured at a modest expense. Thus, a need exists for a reliable smart tire system to discern tire air pressures at a glance and to avoid the above-mentioned problems.

### BRIEF SUMMARY OF THE INVENTION

In view of the foregoing disadvantages inherent in the known tire pressure indicator systems art, the present invention provides a novel at-a-glance tire pressure indicating system. The general purpose of the present invention, which will be described subsequently in greater detail is to provide a reliable and efficient tire pressure indication system.

The pneumatic tire pressure indication system as disclosed herein preferably comprises a pneumatic pressure indicator strip that is vulcanized to a pneumatic tire for use on vehicles. The pneumatic pressure indicator strip may comprise a pressure sealed tube chamber that contains a colored fluid and is sidewall-affixed to the pneumatic tire such that an individual is able to visually examine the colored fluid contained within the pneumatic pressure indicator strip to visually discern what the (relative) pressure of the pneumatic tire is. The pneumatic pressure indicator strip preferably contains a predetermined volume of colored fluid such that when the pneumatic tire is at a predetermined mass force per area, the colored fluid is caused to completely contact the inside surface of the outside diameter of the pneumatic pressure indicator strip providing a colored at-a-glance indication of the interior pressure (taking the cross-sectional form of an ellipse.) The predetermined volume of colored fluid is also such that when the pneumatic tire pressure is less than a predetermined mass force per area, the colored fluid does not completely contact the inside surface of the outside diameter of the pneumatic pressure indicator strip indicating that the tire is low on air (taking the general form of a circular cross-section—sphere—due to the decreased pressure acting upon the pneumatic pressure indicator strip.) Further, the pneumatic pressure indicator strip may have other visual indications such as air-bubbles, the colored fluid occupying only a lower portion of the pneumatic pressure indicator strip (nearest the bottom of the tire sidewall relative to the ground) or different colored fluid in other embodiments.

The colored fluid may comprise a low viscosity liquid with a depressed freezing point compatible with colder climates and can be matched to an exterior body paint color as well. The pneumatic tire pressure indication system colored fluid can be a glycol or an alcohol base or other suitable (preferably environmentally-friendly fluid.)

The pneumatic pressure indicator strip may be manufactured as an integral construction with the pneumatic tire in preferred embodiments and is transparent (see through), flexibly-deformable material, expanding and contracting with the tire for maximum longevity and retained-accuracy. The design is such that the colored fluid occupies the lower portion of the pneumatic pressure indicator strip when the pneumatic tire is under-pressured. The pneumatic pressure indicator strip preferably comprises an elliptical profile when the tire is correctly pressured allowing the colored fluid to be viewed on the sidewall of the tire via the transparent pneumatic pressure indicator strip. The pneumatic pressure indicator strip comprises an elliptical profile at correct pressure due to the pressure acting upon the device from inside the tire and equalizing with the ambient pressure (from outside the tire.) Further, in this profile the tire is dynamically-balanced for use on vehicles to prevent shaking. Vehicle(s) within this disclosure may comprise automobiles, motorcycles, bicycles, or other land modes of transportation utilizing pneumatic tires.

The pneumatic tire pressure indication system further comprises a kit as discussed herein having at least one pneumatic tire(s) (or set of tires) with pneumatic pressure indicator strip(s) for use on vehicles, and a set of user instructions.

The method of use for a pneumatic tire pressure indication system may comprise the steps of: observing the relative position of the colored fluid within the pneumatic pressure indicator strip located on a sidewall of the pneumatic tire to determine a relative air pressure within the pneumatic tire; and adding or removing air from the pneumatic tire as needed to achieve a desired relative air pressure within the pneumatic tire.

The present invention holds significant improvements and serves as a pneumatic tire pressure indication system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Safe Tire, constructed and operative according to the teachings of the present invention.

FIG. 1 shows a perspective view illustrating a pneumatic tire pressure indication system in an in-use condition according to an embodiment of the present invention.

FIG. 2 is another perspective view illustrating the pneumatic tire pressure indication system according to an embodiment of the present invention of FIG. 1.

FIG. 3 is a perspective view illustrating various colored fluids contained within pneumatic pressure indicator strips as used in the pneumatic tire pressure indication system according to an embodiment of the present invention of FIG. 1.

FIGS. 4A-4C are perspective view illustrating a relative location of the pneumatic pressure indicator strip according to an embodiment of the present invention of FIG. 1. More specifically, FIGS. 4A and 4B show under-inflated and properly inflated conditions, respectively and FIG. 4C shows a side view of the pneumatic tire of the pneumatic tire pressure indication system according to an embodiment of the present invention of FIG. 1.

FIG. 5 illustrates the safe tire as used on bicycle according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a pneumatic tire pressure indication system and more particularly to a (smart) safe tire (system) as used to improve the speed and convenience of checking relative tire pressure.

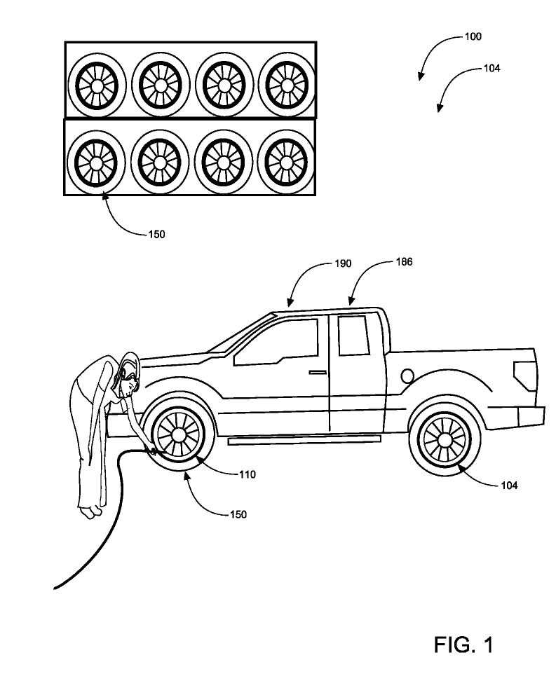

Referring now to the drawings by numerals of reference there is shown in FIG. 1, safe tire 100 providing consumers with pneumatic tire 150 for use on vehicles 186 comprising a novel feature that visually-displays the relative amount of air pressure contained within pneumatic tire 150. This innovative feature can assist individuals in determining how much air is needed in order to fill pneumatic tire 150 to the proper level. As the user pumps air into pneumatic tire 150, colored fluid 140 in pneumatic pressure indicator strip 110 will spread outwardly into an elliptical profile relative to the sidewall or move upwardly filling pneumatic pressure indicator strip 110 on the top portion of pneumatic tire 150 to signal to the individual how much air is in pneumatic tire 150. When pneumatic pressure indicator strip 110 has assumed the proper profile and/or lost all air-bubbles and/or fills the entire pneumatic pressure indicator strip 110, the user will know that pneumatic tire 150 has the proper amount of air therein.

Pneumatic pressure indicator strip 110 within this particular embodiment preferably contains a predetermined volume of colored fluid 140 such that when pneumatic tire 150 is at a predetermined mass force per area, colored fluid 140 is caused to completely contact an inside surface of an outside diameter of pneumatic pressure indicator strip 110. Inside surface is thereby in complete touch-contact with colored fluid 140 around its entire circumference.

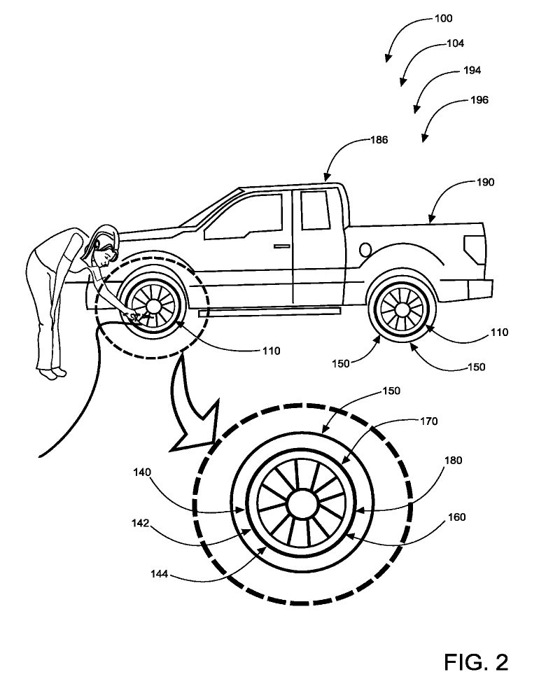

Referring now to FIG. 2, showing pneumatic tire 150 for use on vehicle(s) 186. This concept may be applied to various types of pneumatic tire(s) 150, including those found on bicycles 196, vehicles 186, and motorcycles (not shown.) The device substantially prevents pneumatic tire 150 for use on vehicles 186 from blowing out due to under or overinflating and can also alert the user when the pressure is too low. Safe tire 100 comprises a pneumatic tire 150 for use on vehicles 186 having an option/feature that clearly displays pneumatic tire 150 air pressure in a relative and passive manner. It should be appreciated that the present invention is to be used for ‘relatively’ determining tire pressure(s) and that exacting means including tire pressure gauges and the like should be used for an exact reading.

Pneumatic tire pressure indication system 104 as mentioned comprises colored fluid 140 which may be color-matched to an exterior body paint color of vehicle(s) 186. Pneumatic pressure indicator strip 110 may be available in a wide variety of colors. The exact specifications may vary such that different colors, densities, fluids and the like may be employed. Pneumatic pressure indicator strip 110 contains a predetermined volume of colored fluid 140 (dependent on tire size) such that when pneumatic tire 150 is pressured to less than a predetermined mass force per area, colored fluid 140 does not completely contact an inside surface of an outside diameter of pneumatic pressure indicator strip 110. Pneumatic tire pressure indication system 104 is for use on vehicle(s) 186, wherein vehicle(s) 186 may comprise automobiles 190 and bicycles 196. Upon reading this specification, it should be appreciated that, under appropriate circumstances, considering such issues as user preferences, design preference, structural requirements, marketing preferences, cost, available materials, technological advances, etc., other tire/wheel arrangements such as, for example, those used on wheel barrows, wagons, trailers, used on various truck, car, van, bus, airplane, etc., may be sufficient.

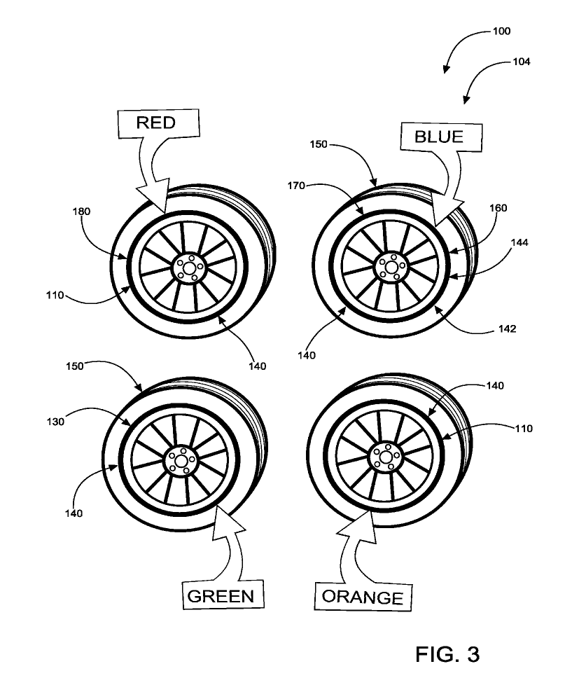

Referring now to FIG. 3 is a perspective view illustrating various colored fluids 140 (here showing Red, Blue, Green, and Orange, other possibilities not shown) contained within pneumatic pressure indicator strips 110 as used in the pneumatic tire pressure indication system 104 according to an embodiment of the present invention of FIG. 1. Shown is standard pneumatic tire 150 as used on automobile(s) 190 with a thin strip of transparent material 160 located on the sidewall(s) of pneumatic tire(s) 150. Pneumatic pressure indicator strip 110 may be located on the exterior of pneumatic tire 150. An indicator may be located on the interior of pneumatic pressure indicator strip 110 in some embodiments. Pneumatic pressure indicator strip 110 may be clear or colored to be visually discernable from the sidewall of pneumatic tire 150. Pneumatic pressure indicator strip 110 allows an individual to view how much air is in pneumatic tire 150 at any given time.

When colored fluid 140 occupies a lower portion of pneumatic pressure indicator strip 110 this serves as an indication that pneumatic tire 150 is under-pressured. As mentioned previously pneumatic pressure indicator strip 110 comprises an elliptical profile when correctly pressured. The elliptical profile allows the correctly dynamically-balanced pneumatic tire 150 to rotate properly thereby substantially preventing shimmy. Colored fluid 140 may comprises glycol 144 or other suitable media such as alcohol 142 or other low viscosity liquid 180. Pneumatic tire 150 and pneumatic pressure indicator strip 110 are preferably vulcanized together in the manufacturing process.

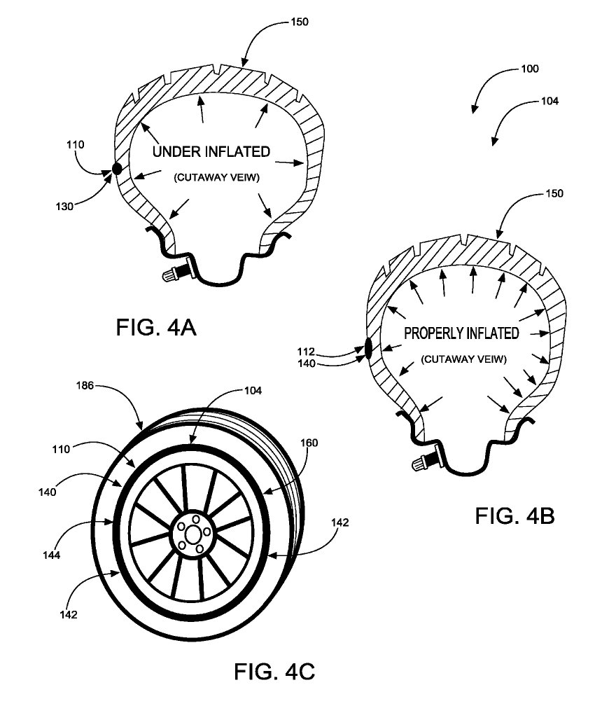

Referring now to FIGS. 4A-4C, showing pneumatic pressure indicator strip 110 comprising a pressure sealed tube chamber; wherein pneumatic pressure indicator strip 110 contains colored fluid 140 as an integral construction with pneumatic tire 150. Pneumatic pressure indicator strip 110 preferably comprises transparent material 160 or in certain embodiments and may comprise a slight tint as a contrasting means if desired. Transparent material 160 is preferably flexibly-deformable 170 such that it deforms at a rate similar to pneumatic tire 150. Pneumatic pressure indicator strip 110 within the preferred embodiment may be sidewall-affixed to pneumatic tire 150 such that an individual is able to visually examine colored fluid 140 contained within pneumatic pressure indicator strip 110 to visually discern a pressure of pneumatic tire 150. Colored fluid 140 preferably comprises low viscosity liquid 180 with a depressed freezing point such that it is suitable for use in a variety of climates and remains fluidic. Colored fluid 140 may comprise alcohol 142. The present figure shows cut-away sectional views of pneumatic tire 150 in under-inflated and properly inflated conditions (FIGS. 4A and 4B, respectively.) Arrows are shown is a relative indication of the amount of PSI contained within pneumatic tire 150. FIG. 4C shows a side view of pneumatic tire 150 of pneumatic tire pressure indication system 104.

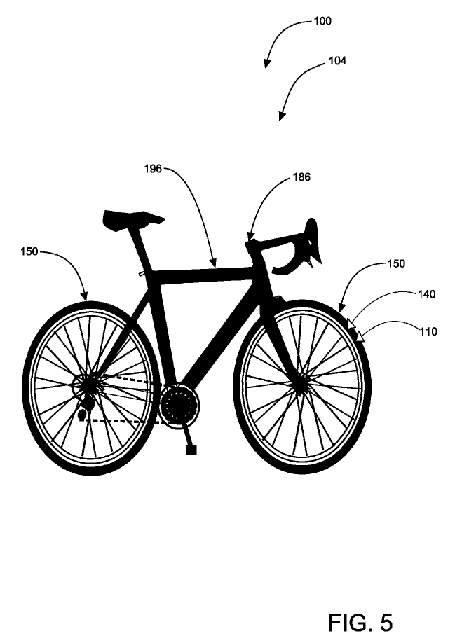

Referring now to FIG. 5, showing safe tire 100 as used on bicycle 196. In a similar fashion the present invention may be used on motorcycles and other pneumatically-wheeled vehicles as aforementioned. Pneumatic tire pressure indication system 104 may be sold as kit comprising the following parts: at least one pneumatic tire 150 (preferably a set of pneumatic tires 150) with pneumatic pressure indicator strip(s) 110 for use on vehicle(s) 186 and a set of user instructions. Pneumatic tire pressure indication system 104 may be manufactured and provided for sale in a wide variety of sizes, colors (to match vehicle(s) 186) and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient. It should be noted that the steps described in the method of use can be carried out in many different orders according to user preference.

A method of use for a pneumatic tire pressure indication system 104 may comprise the steps of: step one observing the relative position of the colored fluid 140 within the pneumatic pressure indicator strip 110 located on a sidewall of pneumatic tire 150 to determine a relative air pressure within pneumatic tire 150; and step two adding or removing air from pneumatic tire 150 as needed to achieve a desired relative air pressure within the pneumatic tire 150. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A pneumatic tire pressure indication system comprising:
a pneumatic pressure indicator strip;
a pneumatic tire for use on vehicles;
wherein said pneumatic pressure indicator strip is a pressure sealed tube chamber;
wherein said pneumatic pressure indicator strip contains a colored fluid; and
wherein said pneumatic pressure indicator strip is sidewall-affixed to said pneumatic tire such that an individual is able to visually examine said colored fluid contained within said pneumatic pressure indicator strip to visually discern a relative pressure of said pneumatic tire.

2. The pneumatic tire pressure indication system of claim 1 wherein said pneumatic pressure indicator strip contains a predetermined volume of said colored fluid such that when said pneumatic tire is at a predetermined mass force per area, said colored fluid is caused to completely contact an inside surface of an outside diameter of said pneumatic pressure indicator strip.

3. The pneumatic tire pressure indication system of claim 1 wherein said pneumatic pressure indicator strip contains a predetermined volume of said colored fluid such that when said pneumatic tire when pressured to less than a predetermined mass force per area, colored fluid does not completely contact an inside surface of an outside diameter of said pneumatic pressure indicator strip.

4. The pneumatic tire pressure indication system of claim 1 wherein said pneumatic pressure indicator strip is an integral construction with said pneumatic tire.

5. The pneumatic tire pressure indication system of claim 1 wherein said colored fluid is matched to an exterior body paint color of said vehicle.

6. The pneumatic tire pressure indication system of claim 1 wherein said pneumatic pressure indicator strip comprises a transparent material.

7. The pneumatic tire pressure indication system of claim 6 wherein said transparent material is flexibly-deformable at a rate comparable to said pneumatic tire.

8. The pneumatic tire pressure indication system of claim 1 wherein said colored fluid comprises a low viscosity liquid with a depressed freezing point.

9. The pneumatic tire pressure indication system of claim 1 wherein said colored fluid occupies a lower portion of said pneumatic pressure indicator strip when said pneumatic tire is under-pressured.

10. The pneumatic tire pressure indication system of claim 1 wherein said pneumatic pressure indicator strip comprises an elliptical profile when correctly pressured.

11. The pneumatic tire pressure indication system of claim 1 wherein said pneumatic pressure indicator strip when comprising an elliptical profile is correctly dynamically-balanced.

12. The pneumatic tire pressure indication system of claim 4 wherein said pneumatic tire for use on vehicles and said pneumatic pressure indicator strip are vulcanized together.

13. The pneumatic tire pressure indication system of claim 1 wherein said colored fluid comprises glycol.

14. The pneumatic tire pressure indication system of claim 1 wherein said colored fluid comprises alcohol.

15. The pneumatic tire pressure indication system of claim 1 wherein said pneumatic tire is for use on vehicle(s), said vehicle(s) comprising automobiles.

16. The pneumatic tire pressure indication system of claim 1 wherein said pneumatic tire is for use on vehicle(s), said vehicle(s) comprising motorcycles.

17. The pneumatic tire pressure indication system of claim 1 wherein said pneumatic tire is for use on vehicle(s), said vehicle(s) comprising bicycles.

18. A pneumatic tire pressure indication system comprising:
a pneumatic pressure indicator strip;
a pneumatic tire for use on vehicles;
wherein said pneumatic pressure indicator strip is a pressure sealed tube chamber;
wherein said pneumatic pressure indicator strip contains a colored fluid;
wherein said pneumatic pressure indicator strip contains a predetermined volume of said colored fluid such that when said pneumatic tire is at a predetermined mass force per area, said colored fluid is caused to completely contact an inside surface of an outside diameter of said pneumatic pressure indicator strip;
wherein said pneumatic pressure indicator strip comprises an elliptical profile when correctly pressured;
wherein said pneumatic pressure indicator strip contains a predetermined volume of said colored fluid such that when said pneumatic tire when pressured to less than a predetermined mass force per area, colored fluid does not completely contact said inside surface of said outside diameter of said pneumatic pressure indicator strip;
wherein said colored fluid occupies a lower portion of said pneumatic pressure indicator strip when said pneumatic tire is under-pressured;
wherein said pneumatic pressure indicator strip is an integral construction with said pneumatic tire;
wherein said colored fluid is color-matched to an exterior body paint color of said vehicle;
wherein said pneumatic pressure indicator strip comprises a transparent material;
wherein said transparent material is flexibly-deformable;
wherein said colored fluid comprises a low viscosity liquid with a depressed freezing point;
wherein said pneumatic pressure indicator strip when comprising an elliptical profile is correctly dynamically-balanceable;
wherein said pneumatic tire for use on vehicles and said pneumatic pressure indicator strip are vulcanized together;
wherein said colored fluid comprises glycol or alcohol;
wherein said pneumatic tire is for use on vehicle(s), said vehicle(s) comprising automobiles, and/or motorcycles and/or bicycles; and
wherein said pneumatic pressure indicator strip is sidewall-affixed to said pneumatic tire such that an individual is able to visually examine said colored fluid contained within said pneumatic pressure indicator strip to visually discern a pressure of said pneumatic tire.

19. The pneumatic tire pressure indication system of claim 18 further comprising a kit having at least one said pneumatic tire(s) with said pneumatic pressure indicator strip(s) for use on said vehicles and a set of user instructions.

20. A method of using a pneumatic tire pressure indication system comprising the steps of:
observing a relative position of a colored fluid within a pneumatic pressure indicator strip located on a sidewall of a pneumatic tire to determine a relative air pressure within said pneumatic tire; and
adding or removing air from said pneumatic tire as needed to achieve a desired said relative air pressure within said pneumatic tire.
